(19) United States
(12) Patent Application Publication
(10) Pub. No.: US 2014/0246418 A1
(43) Pub. Date: Sep. 4, 2014

(54) Toaster Oven with Improved Access to Cooking Cavity

(71) Applicant: HAMILTON BEACH BRANDS, INC., Glen Allen, VA (US)

(72) Inventors: Guoyao Ye, Glen Allen, VA (US); Mark Francis Turner, Machanicsville, VA (US); Michael Garman, Moseley, VA (US); Mark K. Romandy, Midlothian, VA (US); Mark C. Steiner, Midlothain, VA (US)

(73) Assignee: Hamilton Beach Brands, Inc., Glen Allen, VA (US)

(21) Appl. No.: 13/781,950

(22) Filed: Mar. 1, 2013

(51) Int. Cl. A21B 1/02

(52) U.S. Cl. CPC A21B 1/02
USPC 219/391

(57) ABSTRACT

A toaster oven comprises a housing, an opening defined in the housing, and a door. The housing comprises an upper panel, a bottom panel, and opposing side panels together defining a food cavity. The door is movably affixed to the housing and selectively movable between a closed position closing off the opening thereby blocking access to the food cavity and an open position enabling access to the food cavity. The door has a front panel and opposing side panels. A portion of a front edge of at least one side panel of the housing is recessed back from the front panel of the door when the door is in the closed position. The recessed portion of the front edge of at least one side panel of the housing is enclosed by the corresponding side panel of the door when the door is in the closed position.

### FIELD OF THE DISCLOSURE

The present disclosure relates generally to appliances, and more particularly to toaster ovens.

### BACKGROUND OF THE DISCLOSURE

Toaster ovens are well known. Toaster ovens are multi-purpose appliances that may be used to toast bread products or cook food items, to name just two uses. Conventional toaster ovens typically comprise a housing with a generally cuboid shape. A cooking cavity is defined within the housing. A generally rectangular opening is defined in the front wall of the housing to enable access to the cooking cavity. A generally rectangular door is hingedly affixed to the housing to selectively enable access (when the door is in an open position) or block access (when the door is in a closed position) to the cooking cavity. The door is typically either hinged at the top edge such that the door opens up, or hinged at the bottom edge such that the door opens down. The door typically comprises either a metallic frame surrounding a clear glass window or comprises a clear glass door to which metallic hinge(s) and a handle are affixed. A metallic cooking grid is selectively mountable within the cooking cavity, often at more than one level. Heating elements are typically mounted at the top of the cooking cavity (i.e., above the food) and the bottom of the cooking cavity (i.e., below the food).

Toaster ovens often have cooking cavities wide and deep enough to hold four or even six slices of bread lying flat (in a 2×2 or 2×3 arrangement), and as such are commonly termed “four slice” or “six slice” toaster ovens. However, it is known to cook many different types of foods in a toaster oven.

The relatively deep size of the cooking cavity, coupled with the relatively low and narrow access to the cooking cavity afforded by the door opening, can make it difficult to access food that is positioned toward the rear of the cooking cavity. Such food may need to be accessed, for example, to remove the item(s) in the rear that has finished cooking before the item(s) in the front, or to perform an additional cooking step (e.g., topping with cheese or adding seasonings) to the item(s) in the rear. During toasting or cooking, the housing, door (except the handle), and cooking grid all become extremely hot and dangerous to touch. Thus, a user who reaches into the cooking cavity risks burning his/her hand if a hot surface is inadvertently touched. It is possible to slide the cooking grid partially out of the cooking cavity to facilitate access to the food item(s) toward the rear of the cavity, however a utensil, pot holder, or the like must be used to slide the cooking grid due to the high temperature of the cooking grid.

It has heretofore not been discovered how to create a toaster oven that is capable of toasting a bread product and cooking other food products, while providing improved access to the cooking cavity to safely increase access to the rear portion of the cooking cavity.

The toaster oven of the following disclosure accomplishes the above and other objectives and overcomes at least the above-described disadvantages of conventional toaster ovens.

### BRIEF SUMMARY OF THE DISCLOSURE

A kitchen appliance for toasting bread products and the like and for cooking food products is disclosed herein. In one embodiment of the subject appliance, the toaster oven comprises a housing, an opening defined in the housing, a door, a cooking grid, and upper and lower heating elements within the housing. The housing comprises an upper panel, a bottom panel, and opposing side panels together defining a food cavity. The opening defined in the housing enables access to the food cavity. The door is movably affixed to the housing and selectively movable between a closed position closing off the opening thereby blocking access to the food cavity and an open position enabling access to the food cavity. The door has a front panel and opposing side panels. The cooking grid is selectively mountable within the housing. The upper heating element is positioned above the cooking grid and the lower heating element is positioned below the cooking grid. A portion of a front edge of at least one side panel of the housing is recessed back from the front panel of the door when the door is in the closed position. The recessed portion of the front edge of at least one side panel of the housing is enclosed by the corresponding side panel of the door when the door is in the closed position.

The upper panel of the housing may comprise a rounded panel, and the front panel of the door may have a correspondingly rounded shape. Each side panel of the door may be pivotably affixed to a corresponding side panel of the housing, such that the door pivots about the rounded panel of the housing when the door moves between the open and closed positions.

The upper panel of the housing may comprise a planar top panel and a planar back panel joined thereto at an angle. The front panel of the door may comprise a planar front panel and a planar top panel joined to the front panel of the door at an angle. A portion of the top panel of the housing may be recessed back from the front panel of the door when the door is in the closed position. The recessed portion of the top panel of the housing may be enclosed by the corresponding top panel of the door when the door is in the closed position.

The door may be removably affixed to the housing. Each side panel of the door may be selectively pivotably affixed to a corresponding side panel of the housing. Each housing side panel and corresponding door side panel may comprise corresponding ones of a male pivot member and a female pivot member. The male pivot member may comprise a mounting base for mounting the male pivot member to the housing side panel or the door side panel, a planar insertion member that is parallel to the housing side panel or door side panel when the male pivot member is mounted thereto, and a spacer therebetween such that the insertion member is spaced apart from the mounting base. The insertion member may have a first pair of opposing sides that are a first distance apart and a second pair of opposing sides that are a second distance apart, the first distance being greater than the second distance. The female pivot member may comprise a mounting base for mounting the female pivot member to the door side panel or the housing side panel, a cylindrical perimeter wall affixed to the mounting base, and an end wall closing off at least a portion of an end of the perimeter wall opposite the mounting base, thereby defining an internal chamber. The internal chamber may be sized to enable the corresponding insertion member to rotate freely when inserted therein. An opening may be defined in the perimeter wall of the female pivot member to enable insertion and removal of the insertion member into and from the internal chamber of the female pivot member, the size of the opening being less than the first distance and greater than the second distance.

Each housing side panel may comprise a female pivot member and each corresponding door side panel may comprise a male pivot member.

Each female pivot member may be affixed to an outer surface of the respective housing side panel, and each male pivot member may be affixed to an inner surface of the respective door side panel.

The respective orientations of the male and female pivot members may be configured such that the door may be removed or replaced only when the door is in the open position.

In addition to the toaster oven, as described above, other embodiments include at least a toaster oven comprising a housing, an opening defined in the housing, a door, a cooking grid, and upper and lower heating elements within the housing. The housing comprises an upper panel, a bottom panel, and opposing side panels together defining a food cavity. The opening defined in the housing enables access to the food cavity. The door is movably affixed and removably affixed to the housing and selectively movable between a closed position closing off the opening thereby blocking access to the food cavity and an open position enabling access to the food cavity. The door has a front panel and opposing side panels, each side panel of the door being selectively pivotably affixed to a corresponding side panel of the housing. The cooking grid is selectively mountable within the housing. The upper heating element is positioned above the cooking grid and the lower heating element is positioned below the cooking grid. Each housing side panel and corresponding door side panel comprise corresponding ones of a male pivot member and a female pivot member. The male pivot member comprises a mounting base for mounting the male pivot member to the housing side panel or the door side panel, a planar insertion member that is parallel to the housing side panel or door side panel when the male pivot member is mounted thereto, and a spacer therebetween such that the insertion member is spaced apart from the mounting base. The insertion member has a first pair of opposing sides that are a first distance apart and a second pair of opposing sides that are a second distance apart, the first distance being greater than the second distance. The female pivot member comprises a mounting base for mounting the female pivot member to the door side panel or the housing side panel, a cylindrical perimeter wall affixed to the mounting base, and an end wall closing off at least a portion of an end of the perimeter wall opposite the mounting base, thereby defining an internal chamber. The internal chamber is sized to enable the corresponding insertion member to rotate freely when inserted therein. An opening is defined in the perimeter wall of the female pivot member to enable insertion and removal of the insertion member into and from the internal chamber of the female pivot member, a size of the opening being less than the first distance and greater than the second distance.

Each housing side panel may comprise a female pivot member and each corresponding door side panel may comprise a male pivot member.

Each female pivot member may be affixed to an outer surface of the respective housing side panel, and each male pivot member may be affixed to an inner surface of the respective door side panel.

Respective orientations of the male and female pivot members may be configured such that the door may be removed and replaced only when the door is in the open position.

The upper panel of the housing may comprise a rounded panel, and the front panel of the door may have a correspondingly rounded shape. Each side panel of the door may be pivotably affixed to a corresponding side panel of the housing, such that the door pivots about the rounded panel of the housing when the door moves between the open and closed positions.

A portion of a front edge of at least one side panel of the housing may be recessed back from the front panel of the door when the door is in the closed position. The recessed portion of the front edge of at least one side panel of the housing may be enclosed by the corresponding side panel of the door when the door is in the closed position.

The upper panel of the housing may comprise a planar top panel and a planar back panel joined thereto at an angle. The front panel of the door may comprise a planar front panel and a planar top panel joined to the front panel of the door at an angle. A portion of at top panel of the housing may be recessed back from the front panel of the door when the door is in the closed position. The recessed portion of the top panel of the housing may be enclosed by the corresponding top panel of the door when the door is in the closed position.

### BRIEF DESCRIPTION OF THE SEVERAL VIEWS OF THE DRAWING(S)

Having thus described the disclosure in general terms, reference will now be made to the accompanying drawings, which are not necessarily drawn to scale. The foregoing summary, as well as the following detailed description of the disclosure, will be better understood when read in conjunction with the appended drawings. It should be understood, however, that the disclosure is not limited to the precise arrangements and instrumentalities shown, wherein:

FIG. 1 is an isometric view of a toaster oven with its door in a closed position, in accordance with embodiments of the present disclosure.

FIG. 2 is an isometric view of the toaster oven of FIG. 1, with its door in the open position.

FIG. 3 is an isometric view of the toaster oven of FIG. 1, with its door removed.

FIG. 4 is an isometric view of the door of the toaster oven of FIG. 1.

FIG. 5 is an isometric view of a toaster oven with its door in a closed position, in accordance with alternative embodiments of the present disclosure.

FIG. 6 is an isometric view of the toaster oven of FIG. 5, with its door in the open position.

### DETAILED DESCRIPTION OF THE DISCLOSURE

Certain terminology is used in the following description for convenience only and is not limiting. The words “lower,” “bottom,” “back,” “front,” “upper,” and “top” designate directions in the drawings to which reference is made. The words “left,” “up,” and “down” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the appliance disclosed herein provide a toaster oven capable of toasting a bread product and cooking other food products, while providing improved access to the cooking cavity to safely increase access to the rear portion of the cooking cavity.

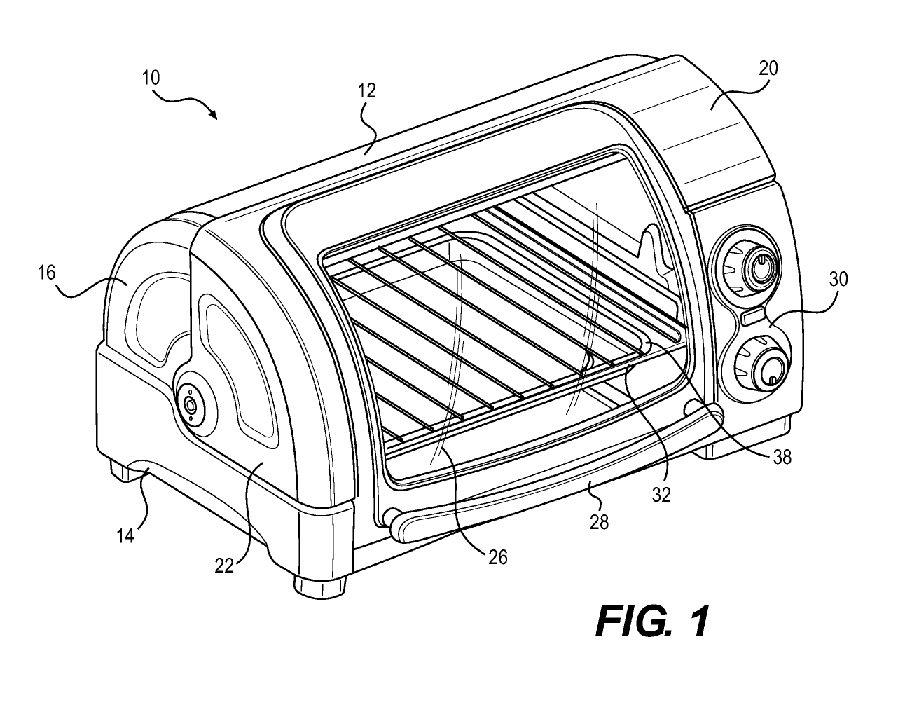

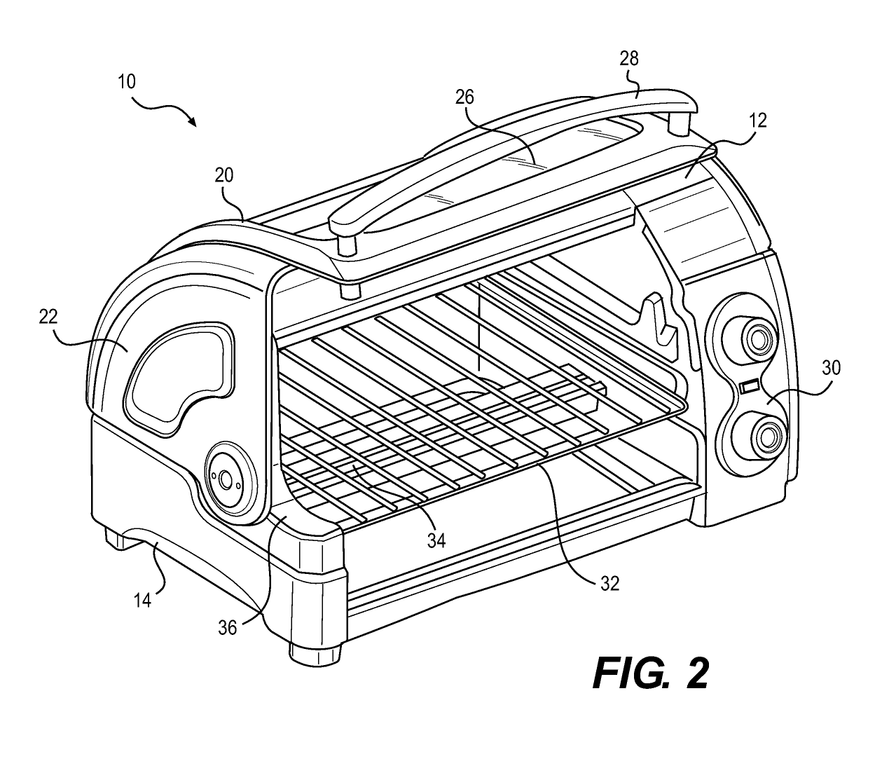

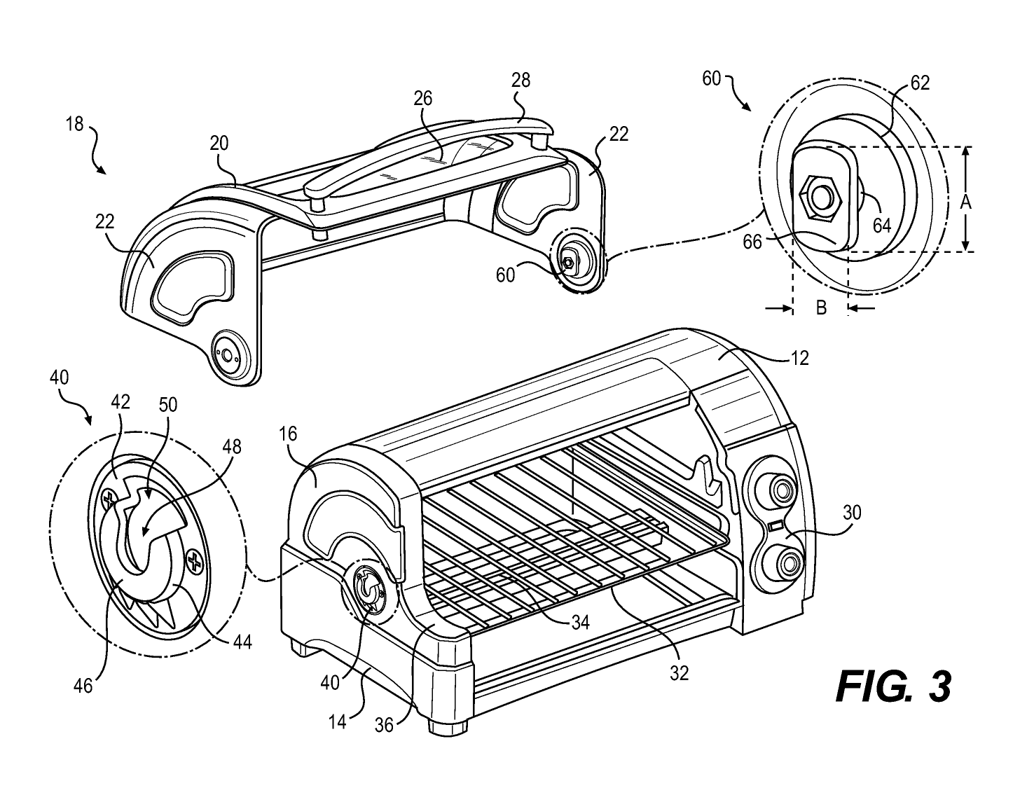

Referring now to FIGS. 1-4 wherein like numerals indicate like elements throughout, there is illustrated a toaster oven 10 in accordance with an embodiment of the present disclosure. Toaster oven 10 comprises a housing having an upper panel 12, a bottom panel 14, and opposing side panels 16 (only one side panel is seen in FIGS. 1-4) together defining a food cavity. An opening is defined in the housing to enable access to the food cavity. The toaster oven 10 further comprises a door 18 movably affixed to the housing and selectively movable between a closed position (see FIG. 1) and an open position (see FIG. 2). The toaster oven opening is best seen in FIG. 3, as the opening is covered by the door in FIG. 1.

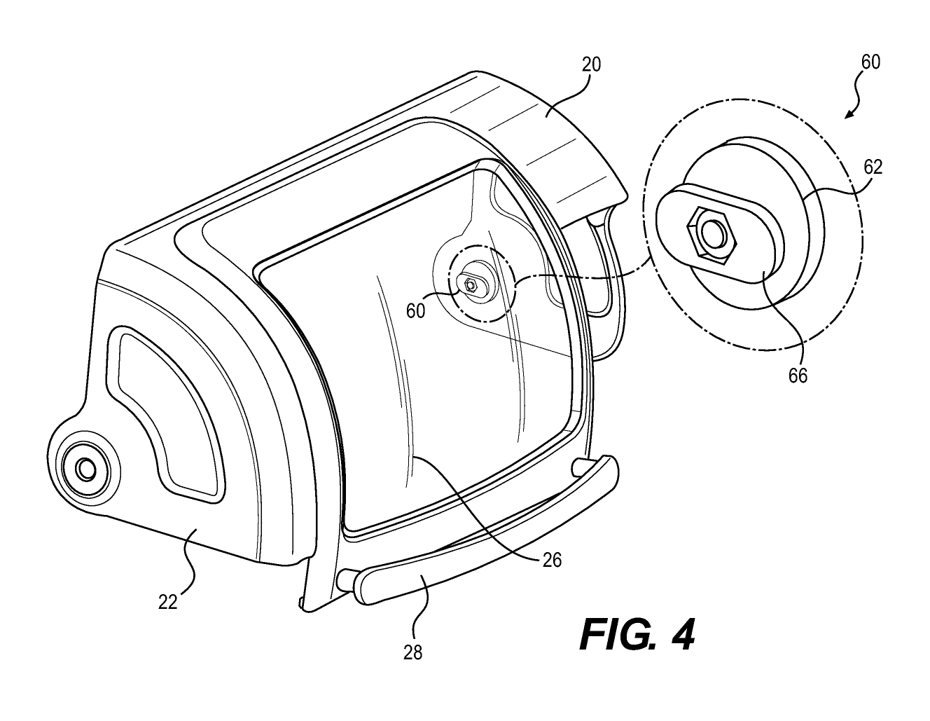

Each side panel 22 of the door 18 is pivotably affixed to a corresponding side panel 16 of the toaster oven housing (described in more detail below). In the closed position, the door 18 closes off the opening thereby blocking access to the food cavity. In the open position, access to the food cavity is enabled. The door 18 comprises a front panel 20 and opposing side panels 22 (only one side panel is seen in FIGS. 1-2; both side panels are seen in FIGS. 3 and 4). The opposing side panels may be mirror images of each other, or may each have a different appearance. Much of the front panel 20 of the door 18 comprises a glass panel 26 to enable a user to view the progress of the toasting/cooking A handle 28 is affixed to the door 18 to enable a user to easily open and close the door. Advantageously and unlike conventional toaster ovens, the door 18 disclosed herein is easily removable from the rest of the toaster oven 10 by a user without using any tools, as described further below.

A cooking grid 32 is selectively mountable within the housing, typically at two or more different levels within the cooking cavity. A cooking pan 38 (shown only in FIG. 1) may also be placed in the cooking cavity. A user interface 30 may have a variety of user input and output elements, such as a temperature control, a timer, and a power light. The toaster oven 10 typically comprises two or more heating elements 34—typically at least one upper heating element (not illustrated) positioned at or near the top of the cooking cavity and at least one lower heating element positioned at or near the bottom of the cooking cavity, although placement and quantity of the elements may vary.

The upper panel 12 of the housing of toaster oven 10 of FIGS. 1-4 has a rounded shape (best seen in FIG. 3). The front panel 20 of the door 18 has a correspondingly rounded shape. The corresponding rounded shapes enable the door to closely pivot about the rounded panel of the housing when the door moves between the open and closed positions, thereby providing a sleek appearance to the toaster oven 10 and minimizing the overall envelope or dimensions of the toaster oven even when the door is in the open position.

Advantageously, a portion 36 of the front edge of at least one side panel of the housing is recessed back from the front panel of the door when the door is in the closed position. In FIG. 3, the left side panel 16 of the housing does not have a uniform rounded shape from back to front, but rather has a portion 36 at the front edge that does not have the same rounded shape. This cutaway portion 36 of the side panel 16 provides greater access to the cooking cavity when the door 18 is open, thereby enabling a user to more easily reach food products placed toward the back of the cooking grid. The recessed portion 36 is enclosed by the corresponding side panel 22 of the door 18 when the door is in the closed position.

As mentioned above, the door 18 is easily removable from the rest of the toaster oven 10. FIG. 3 illustrates the door 18 removed from the toaster oven 10, while FIG. 4 illustrates the removed door 18 in a different orientation. Each side panel 22 of the door 18 is selectively pivotably affixed to a corresponding side panel 16 of the housing. The pivoting capability is provided by corresponding male and female pivot members. Specifically, each housing side panel 16 and corresponding door side panel 22 comprise corresponding ones of a male pivot member 60 and a female pivot member 40. In the embodiment of FIGS. 1-4, each housing side panel 16 comprise a female pivot member 40 and each corresponding door side panel 22 comprise a male pivot member 60. The female pivot member 40 may be on the outer surface of the housing side panel 16 and the male pivot member 60 may be on the inner surface of the door side panel 22 (or vice versa). The male pivot member 60 comprises a mounting base 62 for mounting the male pivot member 60 to the door side panel 22, a planar insertion member 66 that is parallel to the door side panel 22 when the male pivot member 60 is mounted thereto, and a spacer 64 therebetween such that the insertion member 66 is spaced apart from the mounting base 62 to facilitate insertion of the insertion member 66 into the female pivot member 40. The insertion member 66 is wider in one dimension than in the other dimension. In other words, the insertion member 66 has a generally rectangular shape, although the shorter sides are rounded to correspond with the shape of the internal chamber of the female pivot member (described below). On FIG. 3, the distance between the shorter sides is marked as dimension A and the distance between the longer sides is marked as dimension B.

The female pivot member 40 comprises a mounting base 42 for mounting the female pivot member 40 to the door side panel 16, a cylindrical perimeter wall 44 affixed to the mounting base 42, and an end wall 46 closing off at least a portion of the end of the perimeter wall 44 opposite the mounting base 42. As such, the mounting base 42, cylindrical perimeter wall 44, and end wall 46 define an internal chamber 48. The internal chamber 48 is sized to enable the corresponding insertion member 66 to rotate freely when inserted therein. An opening 50 is defined in the perimeter wall 44 of the female pivot member 40 to enable insertion and removal of the insertion member 66 into and from the internal chamber 50 of the female pivot member 40. The width of the opening 50 is greater than the distance between the longer sides (dimension B in FIG. 3), such that the insertion member 66 may be inserted and removed from the internal chamber 48 when the insertion member 66 is oriented such that one of the shorter sides is first inserted. The width of the opening 50 is less than the distance between the shorter sides (dimension A in FIG. 3), such that once the insertion member 66 is inserted into the internal chamber 48 and rotated (such as by closing the door 18), the insertion member 66 cannot be removed from the internal chamber 48 and therefore the door 18 cannot be removed from the toaster oven 10.

In the embodiment of FIGS. 1-4, the female pivot member 40 is mounted such that the opening 50 is at the top, and the male pivot member 60 is mounted such that one of the shorter sides is toward the front of the toaster oven 10 and one of the longer sides is toward the top of the toaster oven 10. Given the orientations of the female and male pivot members in FIGS. 3 and 4, the door 18 is removable and replaceable when the door is open (see FIG. 3). When the door is closed, the door 18 will not be able to be removed (see FIG. 4).

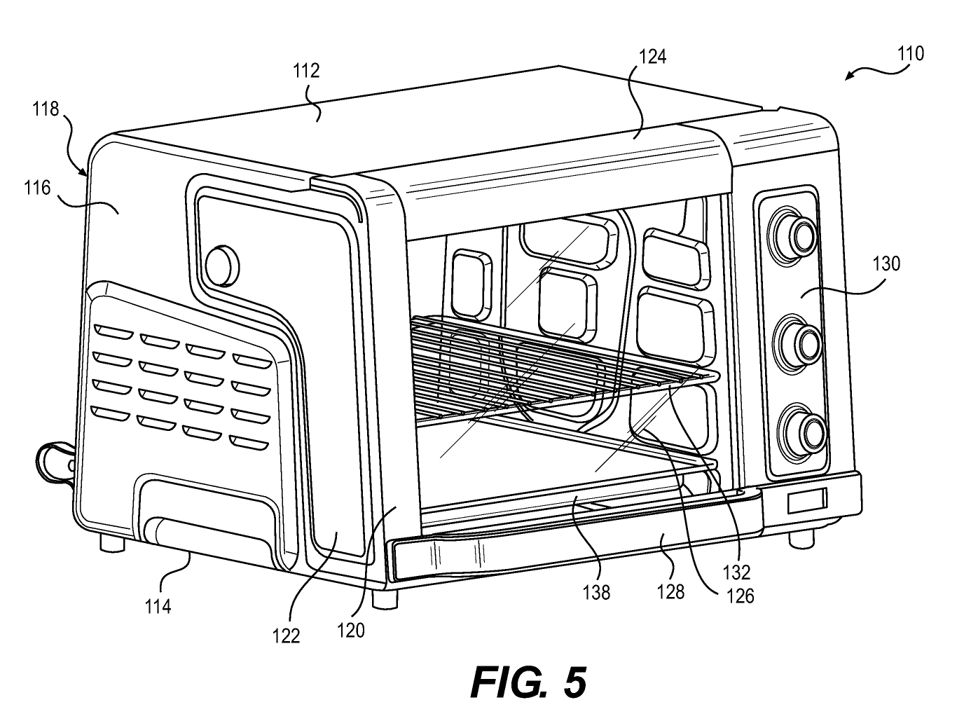

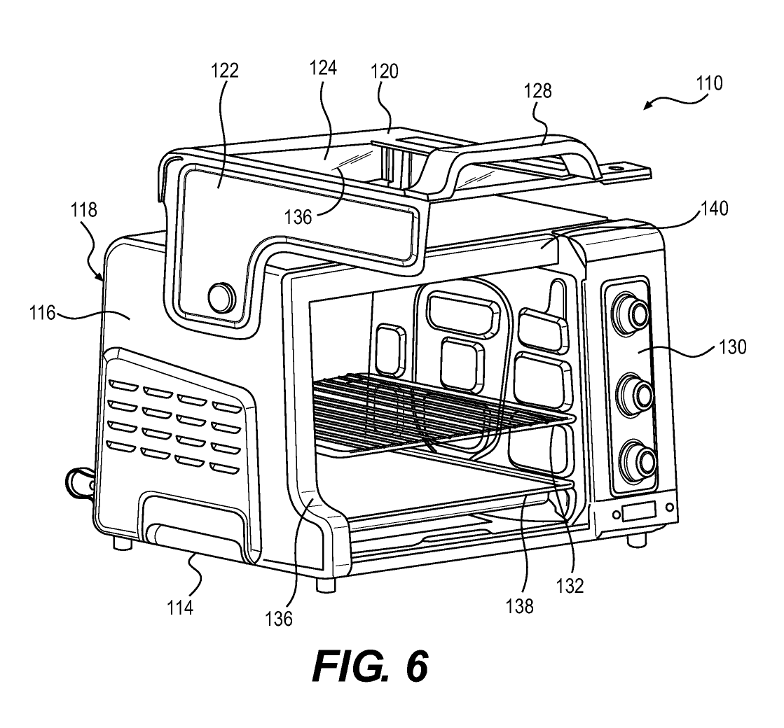

Referring now to FIGS. 5 and 6, a toaster oven 110 is illustrated in accordance with alternative embodiments of the present disclosure. The toaster oven 110 comprises a housing having a planar top panel 112, a planar back panel 118 joined thereto at an angle, a bottom panel 114, and opposing side panels 116 (only one side panel is seen in FIGS. 5 and 6) together defining a food cavity. An opening is defined in the housing to enable access to the food cavity (the opening is best seen in FIG. 6, as the opening is covered by the door in FIG. 5). The toaster oven 110 further comprises a door movably affixed to the housing and selectively movable between a closed position (see FIG. 5) and an open position (see FIG. 6). The door comprises a planar front panel 120, a planar top panel 124 joined to the front panel of the door at an angle, and opposing side panels 122 (only one side panel is seen in FIGS. 5 and 6). The opposing side panels may be mirror images of each other, or may each have a different appearance. Each side panel 122 of the door is pivotably affixed to a corresponding side panel 116 of the toaster oven housing. In the closed position, the door closes off the opening thereby blocking access to the food cavity. In the open position, access to the food cavity is enabled. Much of the front panel 120 of the door comprises a glass panel 126 to enable a user to view the progress of the toasting/cooking

A handle 128 is affixed to the door to enable a user to easily open and close the door. A cooking grid 132 is selectively mountable within the housing, typically at two or more different levels within the cooking cavity. A cooking pan 138 may also be placed in the cooking cavity. A user interface 130 may have a variety of user input and output elements, such as a temperature control, a timer, and a power light. The toaster oven 10 typically comprises two or more heating elements (not illustrated)—typically an upper heating element positioned at or near the top of the cooking cavity and a lower heating element positioned at or near the bottom of the cooking cavity.

Advantageously, a portion 136 of the front edge of at least one side panel of the housing is recessed back from the front panel of the door when the door is in the closed position. In FIG. 6, the left side panel 116 of the housing does not have a uniform straight front edge as is typical, but rather has a recessed portion 136 at the front edge. This cutaway portion of the side housing 116 provides greater access to the cooking cavity when the door is open, thereby enabling a user to more easily reach food products placed toward the back of the cooking grid. The recessed portion 136 is enclosed by the corresponding side panel 122 of the door when the door is in the closed position. Further, a portion 140 of the front edge of the top panel 112 of the housing is recessed back from the front panel of the door when the door is in the closed position. In FIG. 6, the top panel 112 of the housing does not have a uniform straight front edge as is typical, but rather has a recessed portion 140 at the front edge. This cutaway portion 140 of the top panel 112 provides greater access to the cooking cavity when the door is open, thereby enabling a user to more easily reach food products placed toward the back of the cooking grid. The recessed portion 140 is enclosed by the corresponding top panel 124 of the door when the door is in the closed position.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the appliance in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

That which is claimed:

1. A toaster oven comprising:
a housing comprising an upper panel, a bottom panel, and opposing side panels together defining a food cavity;
an opening defined in the housing to enable access to the food cavity;
a door movably affixed to the housing and selectively movable between a closed position closing off the opening thereby blocking access to the food cavity and an open position enabling access to the food cavity, the door having a front panel and opposing side panels;
a cooking grid selectively mountable within the housing; and
upper and lower heating elements within the housing, the upper heating element positioned above the cooking grid and the lower heating element positioned below the cooking grid;
wherein a portion of a front edge of at least one side panel of the housing is recessed back from the front panel of the door when the door is in the closed position; and wherein the recessed portion of the front edge of at least one side panel of the housing is enclosed by the corresponding side panel of the door when the door is in the closed position.

2. The toaster oven of claim 1, wherein the upper panel of the housing comprises a rounded panel; wherein the front panel of the door has a correspondingly rounded shape; wherein each side panel of the door is pivotably affixed to a corresponding side panel of the housing, such that the door pivots about the rounded panel of the housing when the door moves between the open and closed positions.

3. The toaster oven of claim 1, wherein the upper panel of the housing comprises a planar top panel and a planar back panel joined thereto at an angle; wherein the front panel of the door comprises a planar front panel; wherein the door further comprises a planar top panel joined to the front panel of the door at an angle; wherein a portion of the top panel of the housing is recessed back from the front panel of the door when the door is in the closed position; and wherein the recessed portion of the top panel of the housing is enclosed by the corresponding top panel of the door when the door is in the closed position.

4. The toaster oven of claim 1, wherein the door is removably affixed to the housing;
wherein each side panel of the door is selectively pivotably affixed to a corresponding side panel of the housing;
wherein each housing side panel and corresponding door side panel comprise corresponding ones of a male pivot member and a female pivot member;
wherein the male pivot member comprises a mounting base for mounting the male pivot member to the housing side panel or the door side panel, a planar insertion member that is parallel to the housing side panel or door side panel when the male pivot member is mounted thereto, and a spacer therebetween such that the insertion member is spaced apart from the mounting base, the insertion member having a first pair of opposing sides being a first distance apart and a second pair of opposing sides being a second distance apart, the first distance being greater than the second distance;
wherein the female pivot member comprises a mounting base for mounting the female pivot member to the door side panel or the housing side panel, a cylindrical perimeter wall affixed to the mounting base, and an end wall closing off at least a portion of an end of the perimeter wall opposite the mounting base, thereby defining an internal chamber;
wherein the internal chamber is sized to enable the corresponding insertion member to rotate freely when inserted therein; and
wherein an opening is defined in the perimeter wall of the female pivot member to enable insertion and removal of the insertion member into and from the internal chamber of the female pivot member, a size of the opening being less than the first distance and greater than the second distance.

5. The toaster oven of claim 4, wherein each housing side panel comprise a female pivot member and each corresponding door side panel comprise a male pivot member.

6. The toaster oven of claim 5, wherein each female pivot member is affixed to an outer surface of the respective housing side panel; and wherein each male pivot member is affixed to an inner surface of the respective door side panel.

7. The toaster oven of claim 5, wherein respective orientations of the male and female pivot members are configured such that the door may be removed or replaced only when the door is in the open position.

8. A toaster oven comprising:
a housing comprising an upper panel, a bottom panel, and opposing side panels together defining a food cavity;
an opening defined in the housing to enable access to the food cavity;
a door movably affixed and removably affixed to the housing and selectively movable between a closed position closing off the opening thereby blocking access to the food cavity and an open position enabling access to the food cavity, the door having a front panel and opposing side panels, each side panel of the door being selectively pivotably affixed to a corresponding side panel of the housing;
a cooking grid selectively mountable within the housing; and
upper and lower heating elements within the housing, the upper heating element positioned above the cooking grid and the lower heating element positioned below the cooking grid;
wherein each housing side panel and corresponding door side panel comprise corresponding ones of a male pivot member and a female pivot member;
wherein the male pivot member comprises a mounting base for mounting the male pivot member to the housing side panel or the door side panel, a planar insertion member that is parallel to the housing side panel or door side panel when the male pivot member is mounted thereto, and a spacer therebetween such that the insertion member is spaced apart from the mounting base, the insertion member having a first pair of opposing sides being a first distance apart and a second pair of opposing sides being a second distance apart, the first distance being greater than the second distance;
wherein the female pivot member comprises a mounting base for mounting the female pivot member to the door side panel or the housing side panel, a cylindrical perimeter wall affixed to the mounting base, and an end wall closing off at least a portion of an end of the perimeter wall opposite the mounting base, thereby defining an internal chamber;
wherein the internal chamber is sized to enable the corresponding insertion member to rotate freely when inserted therein; and
wherein an opening is defined in the perimeter wall of the female pivot member to enable insertion and removal of the insertion member into and from the internal chamber of the female pivot member, a size of the opening being less than the first distance and greater than the second distance.

9. The toaster oven of claim 8, wherein each housing side panel comprise a female pivot member and each corresponding door side panel comprise a male pivot member.

10. The toaster oven of claim 9, wherein each female pivot member is affixed to an outer surface of the respective housing side panel; and wherein each male pivot member is affixed to an inner surface of the respective door side panel.

11. The toaster oven of claim 9, wherein respective orientations of the male and female pivot members are configured such that the door may be removed and replaced only when the door is in the open position.

12. The toaster oven of claim 8, wherein the upper panel of the housing comprises a rounded panel; wherein the front panel of the door has a correspondingly rounded shape; wherein each side panel of the door is pivotably affixed to a corresponding side panel of the housing, such that the door pivots about the rounded panel of the housing when the door moves between the open and closed positions.

13. The toaster oven of claim 8, wherein a portion of a front edge of at least one side panel of the housing is recessed back from the front panel of the door when the door is in the closed position; and wherein the recessed portion of the front edge of at least one side panel of the housing is enclosed by the corresponding side panel of the door when the door is in the closed position.

14. The toaster oven of claim 13, wherein the upper panel of the housing comprises a planar top panel and a planar back panel joined thereto at an angle; wherein the front panel of the door comprises a planar front panel; wherein the door further comprises a planar top panel joined to the front panel of the door at an angle; wherein a portion of at top panel of the housing is recessed back from the front panel of the door when the door is in the closed position; and wherein the recessed portion of the top panel of the housing is enclosed by the corresponding top panel of the door when the door is in the closed position.
